(19) United States
(12) Patent Application Publication
(10) Pub. No.: US 2007/0276535 A1
(43) Pub. Date: Nov. 29, 2007

(54) AUTOMATED WAREHOUSE FACILITY

(76) Inventor: Gerhard HAAG, Clearwater, FL (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/757,032

(22) Filed: Jun. 1, 2007

Related U.S. Application Data
(63) Continuation-in-part of application No. 10/871,749, filed on Jun. 18, 2004.
Application No. 10/871,749 is a continuation of application No. 10/133,557, filed on Apr. 27, 2002, now Pat. No. 6,851,921.
Application No. 10/133,557 is a continuation-in-part of application No. 09/364,934, filed on Jul. 30, 1999, now abandoned.
Application No. 10/133,557 is a continuation-in-part of application No. 09/790,460, filed on Feb. 22, 2001, now abandoned.
Application No. 09/790,460 is a division of application No. 09/364,934, filed on Jul. 30, 1999, now abandoned.

(51) Int. Cl. G06F 7/00

(52) U.S. Cl. 700/217

(57) ABSTRACT

An automated warehouse facility for warehousing and storing a plurality of items simultaneously in a plurality of varying levels, in which empty pallets circulate simultaneously with the main circulation of goods but separately from it without interfering with storing and retrieving goods on the all levels. The warehouse facility comprises a multi-level building having a plurality of storage racks for simultaneous and independent storing multiple loaded or unloaded pallets. An entrance-floor level of the building includes a terminal for receiving or releasing multiple items simultaneously through an exterior entrance. An interior entrance to the terminal provides access to the storage area and transportation of the loaded pallet. The warehouse facility includes a pallet stacking station for storing the unloaded pallet located over a shuttle aisle that extends under the terminal. A transport system provides simultaneous and independent transporting of the loaded pallet and unloaded items in the storage area.

### CROSS-REFERENCE TO RELATED APPLICATIONS

This application is Continuation-in-Part of U.S. patent application Ser. No. 10/871,749 entitled “AUTOMATED PARKING GARAGE” filed Jun. 18, 2004, which is a Continuation of U.S. patent application Ser. No. 10/133,557, now U.S. Pat. No. 6,851,921, entitled “AUTOMATED PARKING GARAGE”, which is a Continuation-in-Part of U.S. patent applications: Ser. No. 09/364,934 entitled “METHOD AND APPARATUS FOR DISTRIBUTING AND STORING PALLETS IN AN AUTOMATED PARKING FACILITY” filed Jul. 30, 1999; and Ser. No. 09/790,460 entitled “METHOD AND APPARATUS FOR DISTRIBUTING AND STORING PALLETS IN AN AUTOMATED PARKING FACILITY” filed Feb. 22, 2001, which is a Divisional of Ser. No. 09/364,934, the contents of which are herein incorporated by reference.

### BACKGROUND OF THE INVENTION

Automated parking garage systems have been employed since the late 1950's utilizing crane systems, conveyors, hydraulics and pneumatics to transport and store vehicles within a parking facility. Recently, more advanced garage systems have been developed which include computer-controlled, specialized equipment for carrying vehicles to assigned parking spaces in a way similar to the way that computerized assembly lines or warehouses store and retrieve miscellaneous goods. In such assembly line and warehouse systems, a computer assigns a location for each item as it is received from its manufacturer, and robotic equipment carries each item to its assigned location. The same equipment is dispatched to the location when the item requires retrieval. Often, the items stored in a warehouse are placed on pallets to facilitate transportation and storage of the items. The use of pallets as supporting elements for the transport and storing of vehicles is also typical of more advanced automated warehouse facility systems.

Automated parking garage systems typically use one of two methods to store and retrieve vehicles. A first method employs pallets and assigns a separate pallet to each vehicle storage bay. In such systems, when a vehicle is to be parked or stored in a storage bay, the pallet associated with the storage bay is transported from the storage bay to the garage entrance where the vehicle is located. The vehicle is loaded onto the pallet and the pallet carrying the vehicle is transported to the storage bay where both the pallet and vehicle are stored until retrieved.

When a stored vehicle is to be retrieved, the pallet carrying the vehicle is transported from the storage bay to a garage exit. The vehicle is then unloaded from the pallet, and the pallet is transported back to the storage bay until it is needed again to store a vehicle.

Although the first method accomplishes the function of transporting vehicles to and from assigned storage bays, it has significant shortcomings. A first shortcoming is the inefficient use of time when storing or retrieving a vehicle. Using the first method, a driver parking a vehicle is required to idly wait while a pallet is delivered to the garage entrance from an assigned storage bay. Although garages may provide a limited pallet buffer (e.g., multiple pallets), it is not enough to handle the queues that may occur during periods of high volume business, such as in the morning and afternoon.

A second shortcoming is that the first method of handling empty pallets impedes the peak traffic capacity of the garage and fails to provide an endless, continuing and timely stream of pallets.

A further shortcoming of the first automated parking method is that handling empty pallets impedes the primary purpose of automated warehouse machineries, that is, the storing and retrieving of vehicles. Specifically, the same equipment that is used to store and retrieve vehicles is utilized to handle empty pallets thereby promoting inefficient utilization of that equipment.

Yet another significant shortcoming of the first method is that it can only handle one vehicle and one procedure at a time. Thus, systems employing the first prior art method cannot park an incoming vehicle at the same time they are retrieving an empty pallet, and vice versa. As a result, an unacceptably long queue often forms at the entrance of such a garage during periods of high volume business.

According to the second method, a single carrier module is used to service all storage bays without the use of pallets. In such systems, the module is stored at an idle position in an aisle of the garage when it is not in use. When a vehicle is to be parked or stored in a storage bay, the vehicle is loaded from a terminal onto the module. The module carrying the vehicle is transported to the storage bay where the vehicle is unloaded. The empty module is transported back to the idle position while the vehicle remains stored until it is retrieved. Typically, the vehicle is loaded/unloaded to/from the module using either the vehicle's own drive system or a stacker crane that traverses the aisles and reaches from the foundation to the roof.

When a stored vehicle is to be retrieved, the module is transported from the garage entrance to the storage bay in which the vehicle is stored. The vehicle is loaded onto the module and the module carrying the vehicle is transported to the garage exit. The vehicle is then unloaded from the module, and the empty module is transported to the garage idle position where it remains until it is needed to store or retrieve a vehicle.

Although the second method eliminates the need to handle empty pallets, it has several shortcomings. Specifically, it requires excessive handling of the vehicle such as grabbing the tires in one way or another. The second method also makes inefficient use of time when storing and retrieving a vehicle. Further, using the second method puts vehicles at risk for being potentially damaged during transportation (such as by oil or hydraulic fluid from the crane or by drippings from the vehicle to equipment and/or other parked vehicles).

In addition, the preceding methods and systems are limited in the number of items or vehicles received by the facility and stored therein. That is, the methods and systems described above cannot move multiple items concurrently, as the configurations inherently prevent such operations.

### SUMMARY OF THE INVENTION

In accordance with one embodiment of the subject application, there is provided an automated warehousing and storage system.

Further, in accordance with one embodiment of the subject application, there is provided a system for receiving and storing an item in an automated warehouse facility.

Still further, in accordance with one embodiment of the subject application, there is provided a fully automated warehousing and storage system capable of simultaneously receiving a plurality of items, transporting a plurality of items, and retrieving a plurality of items.

Yet further, in accordance with one embodiment of the subject application, there is provided a fully automated system for warehousing and storing a plurality of items simultaneously in a plurality of varying axes.

In accordance with one embodiment of the subject application, there is provided a fully automated warehousing and storage system. The system includes first passageway transport means associated with a first level of an automated warehouse facility adapted for transporting an item along a first passageway associated with the first level. The system further includes vertical lifting means adapted for lifting an item from the first level to the at least one additional level. In addition, the system includes first transition means associated with the first passageway transport means adapted for transitioning the item to and from the vertical lifting means on the first level. The system also incorporates second passageway transport means associated with the at least one additional level of the automated warehouse facility adapted for transporting an item along a second passageway associated with the at least one additional level. Second transition means associated with the second passageway transport means, are also included in the subject system. The second transition means are suitably adapted for transitioning the item to and from the vertical lifting means on the at least one additional level. Furthermore, the system includes control means adapted for controlling the transfer of the item from the first level to the at least one additional level. In accordance with this embodiment of the subject application, the first passageway transport means, the second passageway transport means, and the vertical lifting means operate simultaneously.

In accordance with one embodiment of the subject application, the system further comprises transfer means adapted for transferring an unloaded pallet from an associated pallet storage to the at least one terminal and receiving means adapted for receiving the unloaded pallet from the transfer means, wherein the transfer means returns to the pallet storage prior to loading of an item on the pallet.

In accordance with one embodiment of the subject application, the system further comprises at least one additional passageway transport means associated with the first passageway adapted for transporting an item along the first passageway, wherein the at least one additional passageway transport means operates simultaneously with the first passageway transport means.

In accordance with another embodiment of the subject application, the fully automated warehousing and storage system further comprises at least one additional vertical lifting means adapted for lifting an item from the first level to the at least one additional level.

Further, in accordance with one embodiment of the subject application, there is provided a fully automated method for warehousing and storage.

Still further, in accordance with one embodiment of the subject application, there is provided a method for receiving and storing an item in an automated warehouse facility.

Yet further, in accordance with one embodiment of the subject application, there is provided a fully automated warehousing and storage method capable of simultaneously receiving a plurality of items, transporting a plurality of items, and retrieving a plurality of items.

Yet further, in accordance with one embodiment of the subject application, there is provided a fully automated method for warehousing and storing a plurality of items simultaneously in a plurality of varying axes.

The automated warehouse facility comprises a multi-level building having a plurality of vehicle storage racks in a storage area for storing a loaded pallet or an unloaded pallet. In accordance with one embodiment of the subject application, the automated warehouse facility is suitably adapted to store and move a plurality of vehicles and goods, including the ability to move multiple items simultaneously. An entrance-floor level of the building includes a terminal on for receiving a vehicle, the terminal having an exterior entrance through which the vehicle is driven and, an opposing interior entrance that provides access to the storage area and through which the loaded pallet is transported, the loaded pallet and unloaded pallet adapted to be positioned at floor level in the terminal. The automated warehouse facility includes a pallet stacking station for storing and independently circulating the unloaded pallet, the pallet stacking station located over a shuttle aisle that extends under the terminal. A pallet shuttle that traverses the shuttle aisle to a first position under the terminal for handling the unloaded pallet in the terminal, and to a second position under the pallet stacking station for stacking the unloaded pallet. The garage also includes a transport system for transporting the loaded pallet in the storage area.

The automated warehouse facility also includes a mechanism for delivering and storing pallets. According to another aspect of the subject application directed toward storage of pallets, a pallet shuttle is positioned in a first position under a terminal. The terminal is an area for receiving and discharging a vehicle. It includes a pallet and a first retractable pallet support mechanism supporting the pallet. The method also includes the step of elevating a support platform of the pallet shuttle to support the pallet. The method further includes the steps of retracting the first retractable pallet support mechanism, lowering the support platform and pallet, and moving the pallet shuttle from the first position to a second position under a pallet stacking station for storing a pallet. The support platform is then elevated thereby lifting the pallet into the pallet stacking station. A second retractable pallet support mechanism operative to support the pallet is then engaged, and the support platform is lowered, thereby causing the second retractable support mechanism to support the lowest pallet in the pallet stacking station.

Still another aspect of the subject application is directed toward delivery of a pallet to a terminal of the automated warehouse facility, the pallet shuttle is positioned in a second position under the pallet stacking station. The pallet stacking station includes a pallet stack having a lowermost pallet. The pallet stacking station also includes a second retractable pallet support mechanism supporting the lowest pallet of the pallet stack. The support platform of the pallet shuttle is then elevated, thereby lifting the pallet stack within the pallet stacking station, retracting the second retractable pallet support mechanism, and lowering the support platform, thereby causing the lowermost pallet of the pallet stack to pass through the second retractable support mechanism of the pallet stacking station. The second retractable support mechanism is then engaged, thereby supporting all of the pallets of the pallet stack except the lowermost pallet. The pallet shuttle and the lowermost pallet are then moved from the second position to the first position under the terminal for receiving and discharging a vehicle. The terminal includes the first retractable pallet support mechanism operative to support a pallet. The support platform and the pallet are then elevated, thereby positioning the pallet in the terminal, and the first pallet support mechanism is engaged, thereby supporting the pallet.

It is a further aspect of the subject application to increase the efficiency of an automated warehouse facility by significantly increasing the throughput peak traffic of an automated warehouse facility, and improving the performance of the automated warehouse facility by, for the most part, handling empty pallets separately from the mechanics employed to store and retrieve vehicles on the all levels of the automated warehouse facility. The empty pallets are handled via a separate circulation pattern without the use of the primary equipment.

The automated warehouse facility of the subject application, preferably comprises one or more vertical lift conveyors for transporting items between levels of the automated warehouse facility.

Still other aspects of the subject application will become readily apparent to those skilled in this art from the following description wherein there is shown and described a preferred embodiment of the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive because the total or selective application of modules will always depend on the available ground area, capacity and business requirements. While the illustration shows the automated storage and car provision center on top of the dealership operation it is also alternatively able to be located underground or in the back of a building, depending on local circumstances, optimal solution or traffic planning. The skilled artisan will appreciate that by such a variable/conditional placement of the “automated heart/automated center” the core and scope of the subject application is explicitly maintained as is in the case of selective modular application.

### BRIEF DESCRIPTION OF THE DRAWINGS

For a more complete understanding of the subject application and the advantages thereof, reference is now made to the following description taken in conjunction with the accompanying drawings, in which:

FIG. 1 is a plan view of an automated warehouse facility employing the subject application;

FIG. 2 is an isometric view of a terminal of the automated warehouse facility of FIG. 1;

FIGS. 3A and 3B illustrate isometric views of the terminal of FIG. 2 during the removal of an empty pallet;

FIG. 4 is an isometric view of the terminal of FIG. 2 and an adjacent pallet stacking station;

FIG. 5 is an isometric view of the pallet stacking station of FIG. 4 receiving a pallet for storage;

FIG. 6 is an isometric view of the pallet stacking station of FIG. 5 and a pallet vertical lift in an open position;

FIG. 7 is an isometric view of the pallet vertical lift of FIG. 6 partially descended in an open position;

FIG. 8 is an isometric view of the pallet vertical lift of FIG. 6 fully descended in an open position;

FIG. 9 is an isometric view of the pallet vertical lift of FIG. 6 fully descended in a closed position;

FIG. 10 is an isometric view of the pallet vertical lift of FIG. 6 fully ascended in a closed position;

FIG. 11a is an isometric view of the exterior and interior door of the terminal of FIG. 2;

FIG. 11b is a more detailed isometric view of the terminal of FIG. 2;

FIG. 12 illustrates a more detailed view of the pallet stacking station assembly that includes the pallet stack support mechanism and pallet vertical lift;

FIG. 13 illustrates an end view of the vertical lift conveyor (vertical lift conveyor) assembly;

FIG. 14 illustrates a more detailed view of the mechanisms utilized for retrieving and replacing a pallet, loaded or unloaded, in the terminal;

FIG. 15 illustrates a more detailed view of the carrier module utilized in the levels of the garage other than the entrance level;

FIG. 16 illustrates a more detailed mechanical view of the pallet shuttle; and

FIG. 17 illustrates a more detailed mechanical view of a rack entry module.

### DETAILED DESCRIPTION OF THE PREFERRED EMBODIMENTS

The subject application is directed to a system and method for warehousing and storing an item. In particular, one embodiment of the subject application is directed to a system and method for storing an item in a fully automated warehousing and storage facility. More particularly, one embodiment of the subject application is directed to a fully automated warehousing and storage system and method capable of simultaneously receiving a plurality of items, transporting a plurality of items, and retrieving a plurality of items. Particularly, one embodiment of the subject application is directed to a fully automated system and method for warehousing and storing a plurality of items simultaneously in a plurality of varying axes. In particular, one embodiment of the subject application is directed to a fully automated system and method for warehousing and storing a plurality of items simultaneously in a plurality of varying axes, in which the empty pallets circulate simultaneously with the main circulation of goods, but separately from it without interfering with storing and retrieving goods on the all levels.

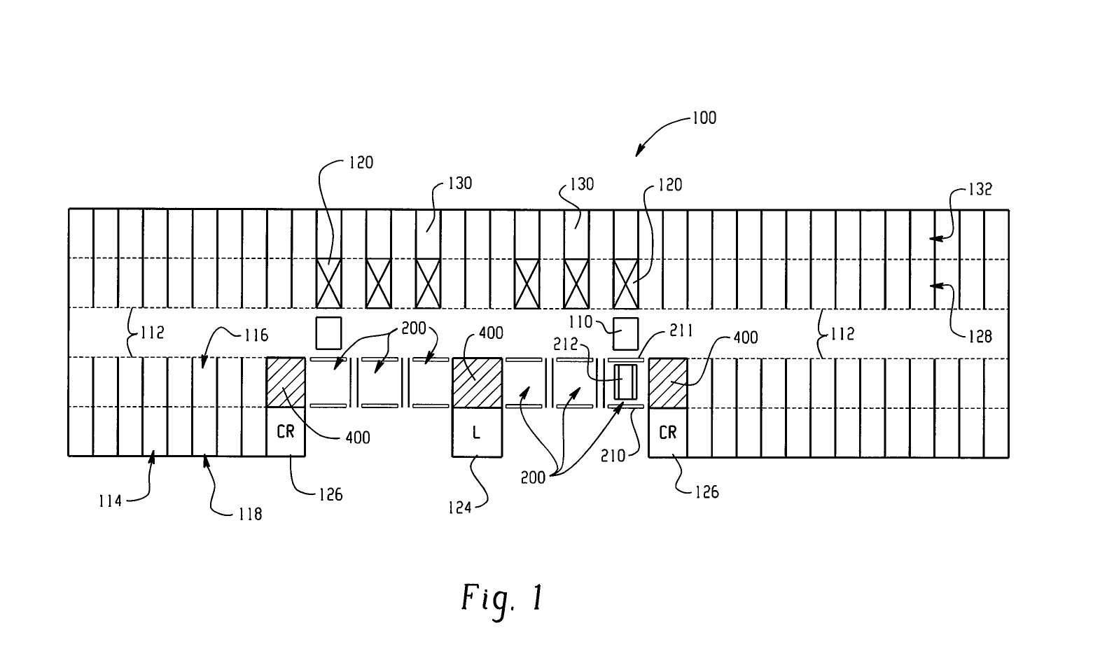

Turning now to FIG. 1, there is shown an example embodiment illustrating a fully automated warehouse facility 100 incorporating the system and method for warehousing and storing items as set forth herein. As depicted in FIG. 1, the automated warehouse facility 100 includes six terminals 200. Each terminal 200 is for receiving and releasing items stored in the automated warehouse facility 100. It will be understood by those skilled in the art that the term item as used herein is correspondingly used to reference any article capable of being stored in accordance with the embodiments of the subject application described herein. It will be appreciated by those skilled in the art that an item is capable of including, for example and without limitation, a uniform storage container, a shipping container, a package, an automobile, a truck, a boat, a motorcycle, or other type of vehicle, construction materials, raw manufacturing materials or manufacturing tools, or the like. In this particular example embodiment, the facility 100 includes three pallet stacking stations 400 that are located near the several terminals 200. Of course, more or fewer terminals 200 and pallet stacking stations 400 are capable of being employed dependent upon the actual and projected throughput peak traffic of the garage 100.

The skilled artisan will appreciate that the pallet stacking stations 400 are shown in FIG. 1 for illustration purposes only and the subject application is not limited to the use of pallets for transporting, storing and retrieving items within the facility 100. In accordance with the example embodiment illustrated in FIG. 1, the one or more pallet stacking stations 400 are for storing empty pallets 212, which pallets are used for supporting items during vehicle storage and retrieval operations. The pallet 212 is removed from the pallet stacking station 400 and distributed to the terminal 200 as necessary to accommodate incoming items for storage in the automated warehouse facility 100. The pallet 212 is removed from the terminal 200 and stored in the pallet stacking station 400 as necessary to accommodate outgoing items. Pallets 212 are transported between the plurality of terminal 200 and pallet stacking station 400 using one or more pallet shuttles (not shown, but described more fully below).

The automated warehouse facility 100 includes a number of levels (or levels) each including a plurality of storage slots 114 for storing items. As shown, each storage slot 114 comprises an interior storage rack 116 and an exterior storage rack 118 such that the storage slot 114 may store up to two or more items. Thus a first item is capable of being stored in the interior storage rack 116 and a second item is capable of being stored in the exterior storage rack 118. In addition to the storage available for items shown in FIG. 1, storage for items is provided on upper and/or lower levels of the automated warehouse facility 100. One or more vertical lift conveyors 120 are provided for transporting items between levels of the automated warehouse facility 100. Note that the disclosed automated warehouse facility architecture is sufficiently flexible to accommodate varying rows of parking, for example, two rows, three rows, fours rows, or the like.

During storage and retrieval operations, an item is transported on a supporting pallet 212 between the storage slot 114 and one of the terminals 200 using a carrier module 110. The carrier module 110 accomplishes such transportation via an aisle 112. The carrier module 110 includes a rack entry module (described in more detail below) for transferring the pallet 212 (in an empty or unloaded state, or carrying an item in a loaded state) between the carrier module 110 and, the interior and exterior storage racks (116 and 118), a terminal 200, or a vertical lift conveyor 120. As will be apparent to those skilled in the art, each of the modules, conveyors, and lifts are capable of independent and simultaneous operation, thereby enabling a high volume of activity within the facility 100 and a high throughput of items into and out of the warehousing facility 100.

The components of the automated warehouse facility 100, including the vertical lift conveyor 120, the carrier module 110, rack entry module, pallet shuttle 250, pallet vertical lift 610 (shown in greater detail below), and turntable mechanism (described in greater detail below) are controlled by a central garage computer control system. The central computer control system, executing the appropriate system control software, is preferably housed in one or more control rooms 126. The automated warehouse facility 100 further includes one or more lobbies 124 wherein a customer is capable of requesting an item be retrieved, and pay for the automated warehousing service.

When an item enters the automated warehouse facility 100, the item is placed into one of the terminal 200 via an open exterior door 210 and is moved onto the pallet 212, both of which s are described in greater detail below. Before the item enters one of the terminals 200, an interior door 211 is closed to prevent the customer from accessing the interior of the automated warehouse facility 100. The customer, and when the item comprises a vehicle, the passengers as well, exit terminal 200, and activate the automated warehousing process via an automated teller located outside and adjacent to the exterior door 210 of the terminal 200, thereby closing the exterior door 210 of the terminal 200. In response thereto, the carrier module 110 moves along the aisle 112 to a position corresponding to the terminal 200 through which the item entered the facility 100. The rack entry module of the carrier module 110 is controlled to remove the loaded pallet 212 from the terminal 200 and retrieve it onto the carrier module 110. In accordance with one embodiment of the subject application, the carrier module 110 includes a turntable is mechanism (described in greater detail below) for use with the storage of various types of vehicles, such as a boat, car, truck, motorcycle, or the like, that then turns 180 degrees so that the vehicle can be retrieved to the terminal 200 wherein the customer can drive out of the terminal 200, instead of having to back out. In an alternative garage embodiment, wherein one or more terminal 200 are constructed on either side of the aisle 112, the turntable feature may not be necessary since the vehicles can now enter a terminal 200 on one side of the aisle 112, and exit via a different terminal on the other side. The central computer determines the availability of a select one of the plurality empty storage racks (116 or 118) in which to store the vehicle with supporting pallet 212. The central computer then directs the carrier module 110 to traverse the aisle 112 to a position corresponding to the predetermined empty storage rack (116 or 118) of the storage slot 114.

In the event that the predetermined storage rack (116 or 118) is located on a different level of the garage 100, the carrier module 110 is positioned across from one of the vertical lift conveyors 120, and the rack entry module is controlled to transfer the pallet 212 with item to the vertical lift conveyor 120. The vertical lift conveyor 120 transports the pallet 212 with item to the appropriate level of the automated warehouse facility 100 where both the pallet 212 and item are transferred to another carrier module 110 on that other level. Once the other carrier module 110 carrying the pallet 212 with item is in a position corresponding to the predetermined storage rack, e.g., exterior storage rack 118 on the necessary level, the rack entry module is controlled to transfer the pallet 212 with item to the predetermined storage rack 118 for storage. One of ordinary skill in the art will understand that similar steps may be executed when retrieving the item from the storage rack 118 on either the upper/lower or entrance levels. The skilled artisan will further appreciate that the foregoing actions of retrieval and storage are capable of occurring simultaneously, thereby resulting in a high throughput of vehicles into and out of the automated parking facility. As will be further appreciated by a skilled artisan, when a predetermined storage rack (116 or 118) is occupied by a pallet 212 with item, one carrier module 110 retrieves the pallet 212 with item from the predetermined storage rack 118 and travels to the side, whereby another carrier module 110 places another pallet 212 with item into the predetermined storage rack 118.

According to one embodiment of the subject application, the pallets 212 that are not in 15 use (i.e., supporting a stored vehicle) are stored in the pallet stacking station 400 by a pallet storage and distribution system. In other words, the pallets 212 are distributed from the pallet stacking station 400 to a nearby terminal 200 only as necessary to accommodate incoming vehicles. Similarly, when an outgoing vehicle vacates its pallet 212, the unloaded pallet 212 may be transferred to the pallet stacking station 400 for storage. The pallets 212 stored in pallet stacking station 400 provide an immediate inventory of empty pallets for operating the automated warehouse facility 100. Additional pallets 212 are capable of being stacked (or accumulated) into pallet bundles in a pallet stack support mechanism (described in greater detail below) and stored for future use in an otherwise empty parking rack (e.g., interior rack 116) on upper/lower levels. Such additional pallets 212 may be stored and retrieved using either dedicated hardware, or the same hardware used for storing and retrieving vehicles on the upper/lower levels. If dedicated hardware is not used, requests for storing and retrieving pallet stacks to/from storage racks are preferably processed during a lull in the operation of the automated warehouse facility 100 (such as at 3:00 am) in order to efficiently utilize the resources of the automated warehouse facility 100.

Note that there are a number of vertical lift conveyors 120 constructed into the automated warehouse facility 100 (six in this embodiment) to provide vertical access between the level s, and that the vertical lift conveyors 120 are constructed on an interior row 128. Thus there are corresponding vertical lift conveyor storage racks 130 “behind” the vertical lift conveyors 120 in an exterior row 132 that can be utilized for storing a vehicle. In order to do so, the vertical lift conveyor 120 must be elevated to the level of the vertical lift conveyor storage rack 130. Thus, a carrier module 110 can slide under a respective loaded pallet 212 and retrieve the loaded pallet 212 from the vertical lift conveyors 120 to a respective vertical lift conveyor storage rack 130. Those skilled in the art will appreciate that for retrieving the vehicle from the vertical lift conveyor storage rack 130, the vertical lift conveyor 120 must be in position at the level of the vertical lift conveyor storage rack 130 from which the vehicle is to be retrieved in order for the carrier module 110 to gain access to the loaded pallet 212 stored in the vertical lift conveyor storage rack 130.

Since the automated warehouse facility 100 is a multi-level building having a plurality of vehicle storage racks, each level has an aisle 112 with associated rail system and one or more carrier modules 110 for traversing the length of the automated warehouse facility 100 at that level. The multiple carrier modules 110 of any particular level operate independently in accordance with instructions from the automated warehouse facility control system. There is also overlapping range of the carrier modules 110 of any given level as they traverse the aisle of that level such that at least two carrier modules 110 can access the same storage slot 114 and the same vertical lift conveyor 120. Of course, the carrier modules 110 of the entrance level also have overlapping range such that any terminal 200 are capable of being accessed by at least two of the carrier modules 110 of the entrance level. Thus, the skilled artisan will appreciate that the example embodiment of FIG. 1 enables multiple items to be transported simultaneously into and out of the facility 100, as well as simultaneous transport of items on each level. In addition, as will be further appreciated by those skilled in the art, the example embodiment of FIG. 1 enables simultaneous transport of empty items, such as empty pallets, on each level.

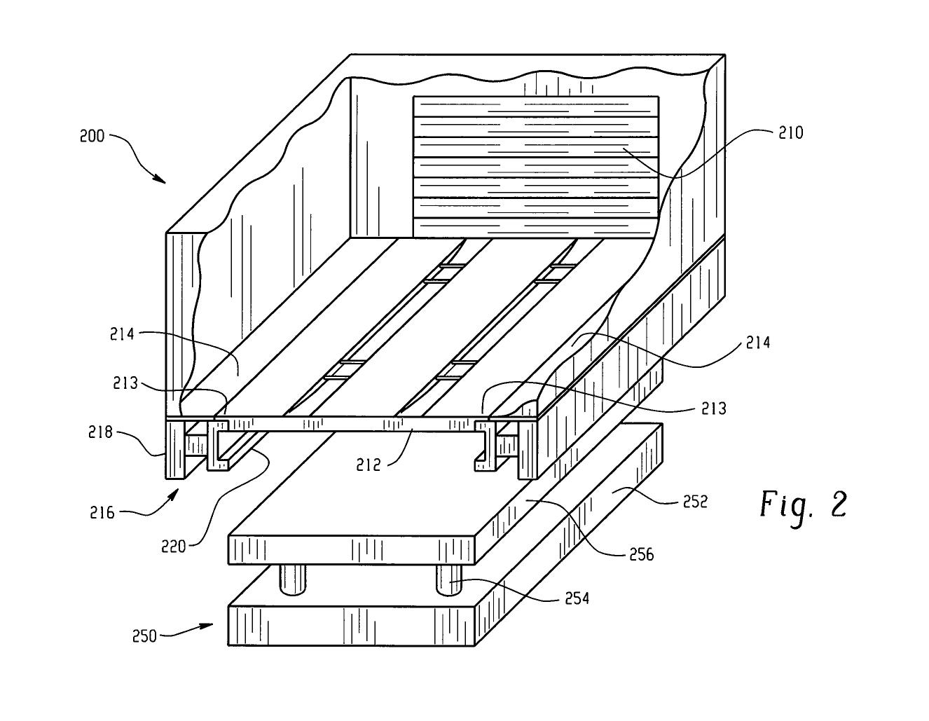

Referring now to FIG. 2, there is illustrated an isometric representation of one of the terminals 200. The terminal 200, such as an entry/exit station, is a bay located on an entrance level of the automated warehouse facility 100 at grade level or other levels where vehicles enter or exit the automated warehouse facility 100. Typically, the terminal 200 will have a width of between approximately fourteen and sixteen feet, and a length of between approximately twenty and twenty-two feet.

As indicated above, the terminal 200 includes the interior door 211 (not shown) for providing access between the terminal 200 and the interior of the automated warehouse facility 100. The terminal 200 further includes the exterior door 210 through which an incoming vehicle may enter or an outgoing vehicle may exit, the automated warehouse facility 100. When entering the automated warehouse facility 100, the incoming item is positioned on the pallet 212, which pallet 212 forms a central portion of the level of terminal 200. The incoming vehicle may be positioned on the pallet 212 using any number of mechanisms, such as grooves, bumpers, lights (e.g., marquees) and acoustic signals. A passenger walkway 214 is provided on either side of the pallet 212 to enable the driver and other passengers of a vehicle to exit the vehicle and terminal 200 of the automated warehouse facility 100 prior to initiation of the vehicle storage process.

The pallet 212 is supported by two retractable pallet supports 216. Each retractable pallet support 216 includes a track 220 and a track retractor 218. The pallet 212 has a pallet lip 213 running the length of each side. A portion of the pallet lip 213 for each side of the pallet 212 lies on top of the respective track 220. The pallet 212 is installed into and removed from the terminal 200 using a pallet shuttle 250. The pallet shuttle 250 is disposed underneath the terminal 200 in a separate runway extending parallel to the aisle 112. The pallet shuttle 250 includes a pallet shuttle base 252 having motive means for moving the pallet shuttle 250 between a first position underneath the terminal 200, and a second position underneath the pallet stacking station 400 (not shown). The motive means for moving the pallet shuttle 250 may include wheels, a track, and/or any other well-known movement mechanisms. The pallet shuttle 250 further includes a pallet shuttle support platform 256 for carrying the empty pallet 212, and a pallet shuttle elevation mechanism 254 for raising and lowering the pallet shuttle support platform 256 (and any pallet 212 supported thereupon).

When the pallet 212 is distributed to one of the terminal 200, the pallet shuttle 250 carrying the pallet 212 is positioned under the appropriate terminal 200. The retractable pallet support mechanism 216 is then controlled to cause the track retractors 218 to drive the tracks 220 to a retracted position, thereby allowing the pallet shuttle 250 to elevate the pallet 212 into the proper position for installation into the terminal 200. To complete the installation of the pallet 212 into the terminal 200, each retractable pallet support mechanism 216 causes the corresponding track retractors 218 to extend, driving the tracks 220 into a support position. Once the tracks 220 are in a support position, the pallet shuttle support platform 256 is lowered, causing the pallet 212 to rest onto the tracks 220, and installation of the pallet 212 is complete, leaving the pallet shuttle 250 free to be used for other tasks. One of ordinary skill in the art will recognize that similar steps may be executed to remove the pallet 212 from the terminal 200 for storing in the pallet stacking station 400.

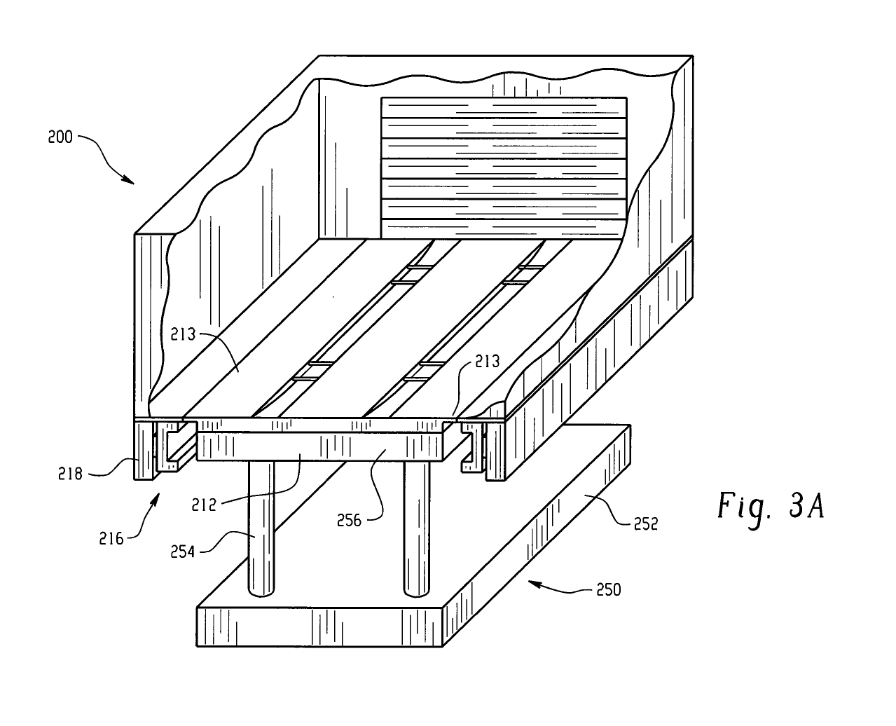

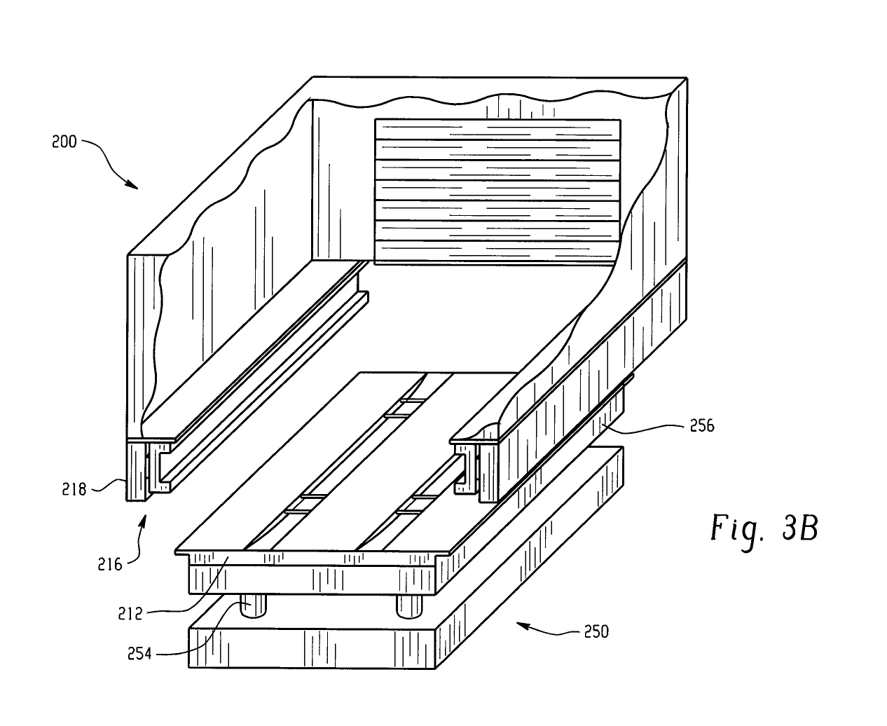

Reference is now to FIGS. 3A-9 that illustrate the facility and operation of the subject application, including the steps performed for storing the pallet 212 that has been vacated by an outgoing vehicle. Of course, the same structural elements can be used to perform steps for distributing the pallet 212 to the terminal 220 for an incoming vehicle.

FIG. 3A illustrates an isometric representation of the terminal 200, and the facility of the subject application for executing the first steps required for removal of the pallet 212 from the terminal 200. As shown, the pallet shuttle 250 causes the pallet shuttle elevation mechanism 254 to raise the pallet shuttle platform 256 into a position supporting the pallet 212. Each retractable pallet support mechanism 216 then causes the corresponding track retractor(s) 218 to position the tracks 220 in a retracted position, which clears the pallet lip 213 on each of the sides of the pallet 212. The pallet 212 and pallet shuttle support platform 256 are then lowered by the pallet shuttle elevation mechanism 254 by passing through the aperture defined, in part, by the tracks 220.

FIG. 3B shows the status of the pallet shuttle 250 just after the pallet 212 has been removed from the terminal 200. The pallet shuttle 250 is illustrated with the pallet shuttle elevation mechanism 254 in a partially lowered state. Once the pallet shuttle elevation mechanism 254 sufficiently lowers the pallet shuttle support platform 256 and pallet 212, the pallet shuttle 250 transports the pallet 212 to another part of the warehouse facility 100 for storage.

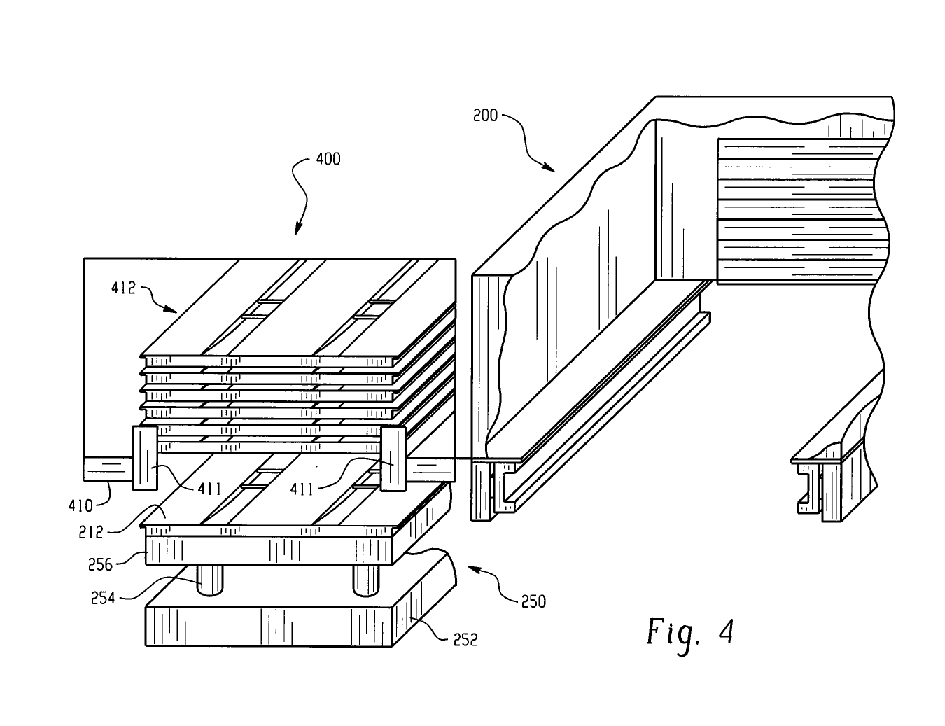

Referring now to FIG. 4, there is illustrated a broader view isometric representation of the terminal 200 showing the pallet stacking station 400 adjacent to the terminal 200. The pallet stacking station 400 includes a pallet stack support mechanism 410 with pallet latches 411 that provide support for a stack of pallets 412 that are suspended over the pallet shuttle 250. The pallet stacking station 400 is used to store the pallets 212 that may be immediately delivered to terminal 200. The pallet stacking station 400 further serves to store the empty pallets 212 recently removed from the terminal 200.

Once the pallet 212 has been removed from the terminal 200, as illustrated hereinabove in FIG. 3A and FIG. 3B, the pallet shuttle base 252 of the pallet shuttle 250 traverses on a shuttle rail system carrying the empty pallet 212 and moves into an alignment position under the pallet stacking station 400. The pallet stacking station 400 and the pallet stack 412 are then lowered to a position where the empty pallet 212, as supported by the pallet shuttle support platform 256, is lifted by the pallet shuttle elevation mechanism 254 into the pallet stacking station 400 from below, and ultimately placed at the bottom of pallet stack 412. The pallet stack support mechanism 410 is configured to permit the pallet 212 to enter the pallet stacking station 400 from underneath, and to provide support for the pallet 212 and the remaining pallets in pallet stack 412 once all of the pallets are rested on pallet support mechanism 410.

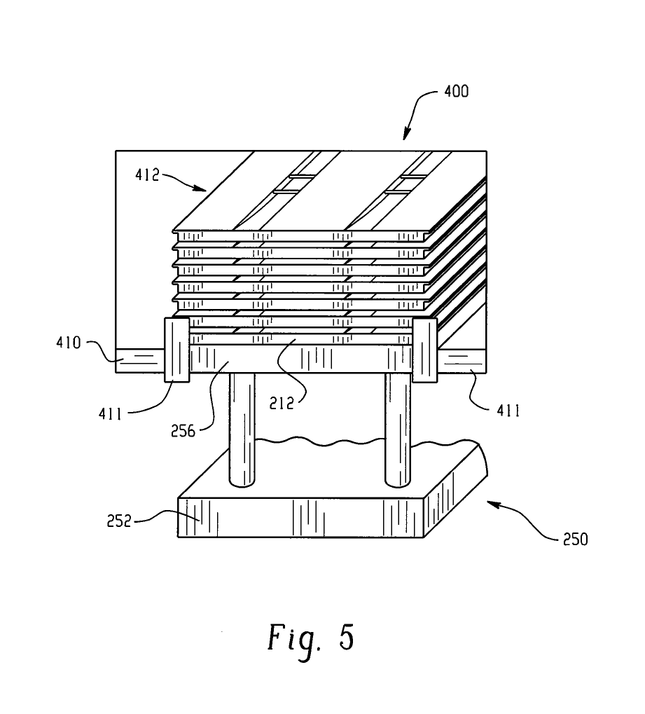

Referring now to FIG. 5, there is illustrated the insertion of the pallet 212 into the pallet stacking station 400. The pallet shuttle 250 is illustrated with the pallet shuttle support platform 256 elevated such that the pallet 212 is lifted under the pallet stack 412 until the pallet stack support mechanism 410 with the pallet latches 411 catch the pallet 212 from underneath and provide vertical support for pallet stack 412, once the pallet shuttle support platform 256 is lowered. The pallet stacking station 400 is designed to accommodate a pallet stack 412 of up to ten pallets. As necessary, the pallet stack 412 may be removed from pallet stacking station 400 by a pallet vertical lift (pallet vertical lift) to an upper/lower level for medium or long-term storage.

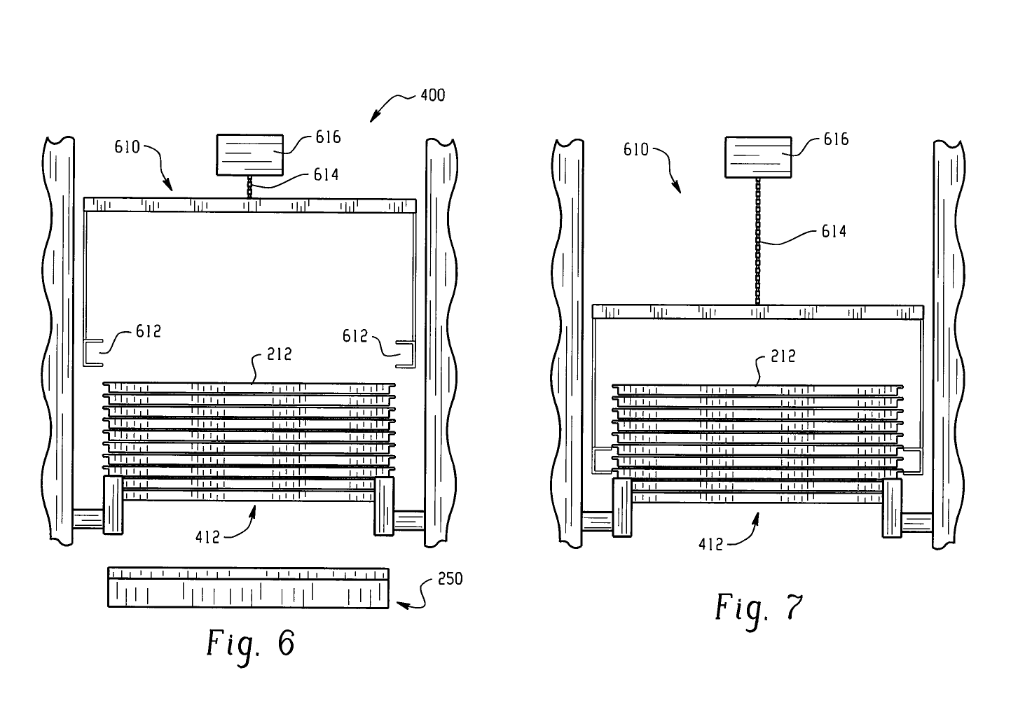

FIGS. 6 through 10 illustrate the structure and steps performed to remove the pallet stack 412 for medium or long-term storage. Referring now to FIG. 6, there is illustrated a representation of the pallet stacking station 400. As shown, the pallet stacking station 400 is filled to capacity with the pallet stack 412 having ten pallets 212. As further shown in FIG. 6, a pallet vertical lift 610 is positioned directly above the pallet stacking station 400 for lifting the pallet stack 412. The pallet vertical lift 610 includes a pair of tongs 612 for supporting the weight of pallet stack 412 during lifting. The pallet vertical lift 610 further includes a pallet vertical lift support 614 and pallet vertical lift motive means 616 for raising and lowering the tongs 612.

Referring now to FIG. 7, there is illustrated the pallet stacking station 400 of FIG. 4, and the pallet vertical lift 610 partially descended with the tongs 612 in an open stance during the removal process of a pallet stack 412. The pallet vertical lift 610 operates to lower the tongs 612 along the sides of pallets 212 of the pallet stack 412, and after the tongs 612 pass the bottom pallet of the pallet stack 412, the pallet vertical lift 610 closes the tongs 612 and then lifts the pallet bundle 412. The pallet stacker then disengages or lifts, to an upper/lower level for medium or long term storage.

When bringing a pallet bundle 412 to the pallet stacking station 400, the pallet vertical lift 610 is fed a pallet bundle 412 from equipment of the upper or lower level. The pallet vertical lift 610 then lowers the pallet bundle 412 into the pallet stack support mechanism 410, where the pallet latches 411 engage the lowest pallet of the pallet bundle 412. The pallet vertical lift 610 then further lowers a short distance (e.g., 1-2 inches), and disengages the tongs 612 to an open stance. Once the pallet vertical lift 610 elevates above the pallet bundle 412, the pallet vertical lift 610 then closes the tongs 612 and rises to an upper level position. The steps are reversed, as indicated in the description hereinafter, when removing a bundle from the pallet stacking station 400 to a storage location.

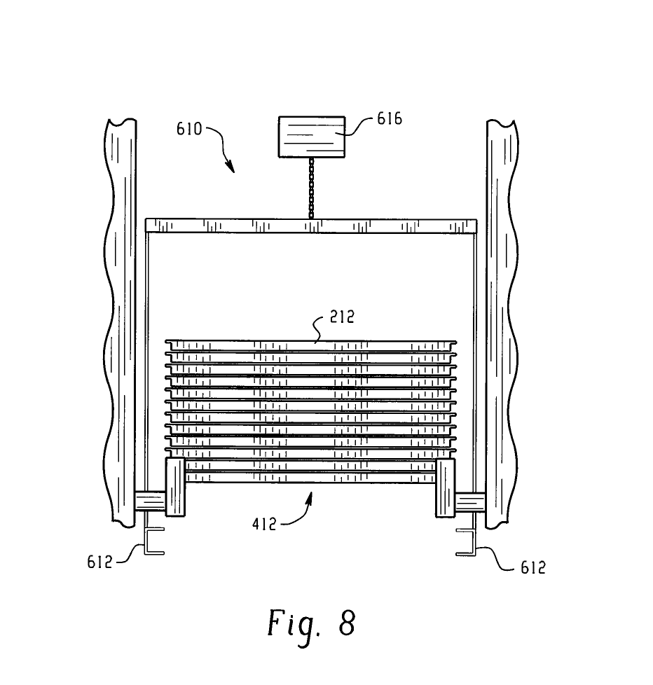

Referring now to FIG. 8, there is illustrated a view of the pallet vertical lift 610 fully descended with the tongs 612 in an open stance.

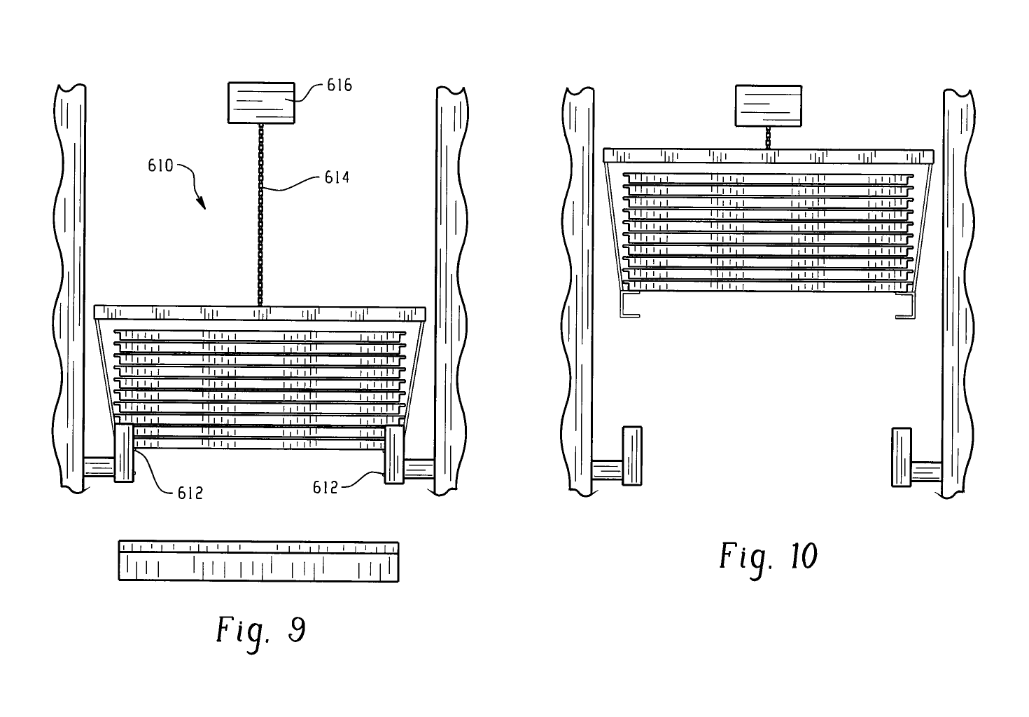

Referring now to FIG. 9, there is illustrated the pallet vertical lift 610 in a fully descended position with the tongs 612 in a closed position. The tongs 612 are illustrated in a closed position in preparation for the pallet vertical lift 610 rising, and thereby supporting the weight of pallet stack 412. The pallet stack 412 is then lifted vertically and removed from pallet stacking station 400 for longer-term storage in another portion of automated warehouse facility 100. Once the pallet vertical lift 610 is in an upper or lower level position, secondary parking machinery may be used to retract the pallet stack 412 from the pallet vertical lift 610. Such secondary parking machinery may then store the pallet stack 412 in an empty vehicle storage rack (e.g. storage rack 116). Of course, a similar process may be employed to retrieve the stored pallet stack 412 and supply it to the pallet vertical lift 610.

The pallet vertical lift 610 lifts the pallet bundle 412 either up or down depending if utilized in an underground automated warehouse facility or an above ground automated warehouse facility; in either case the pallet vertical lift 610 moves the pallet bundle 412 to a level other than the entrance level (i.e., level with the terminal 220).

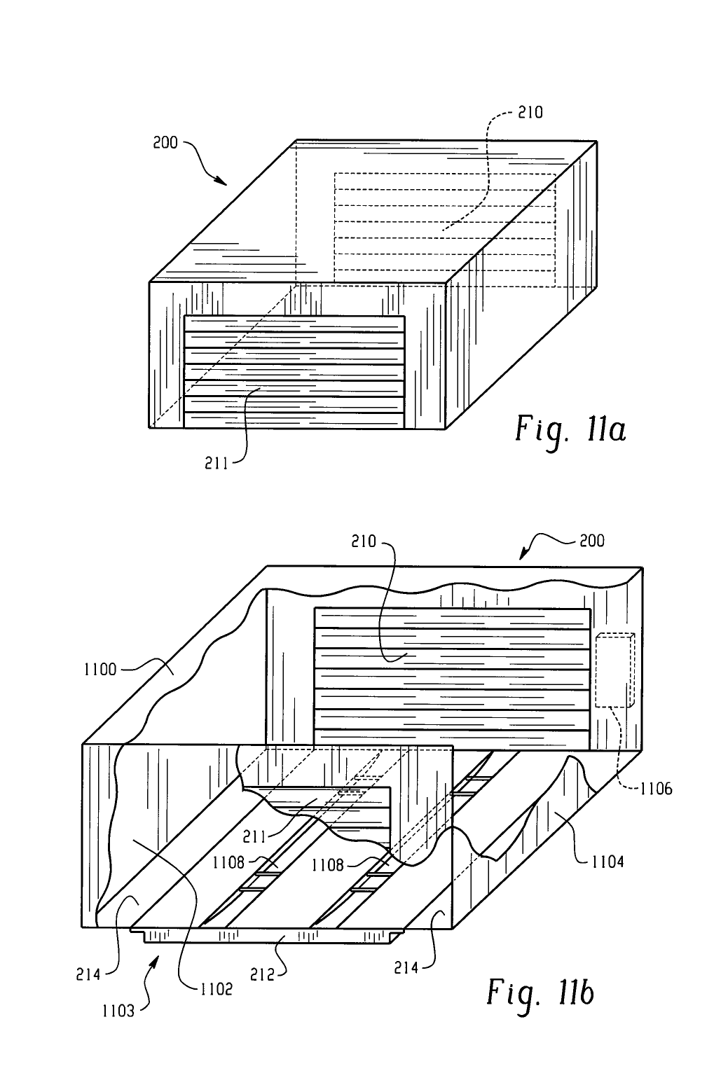

Referring now to FIG. 10, there is illustrated the tongs 612 in a closed stance and the pallet vertical lift 610 in a fully ascended position while supporting pallet stack 412.

Thus, as will be recognized by those skilled in the art, the components of the pallet handling system of the subject application as described herein operate independently and simultaneous with each other enabling an efficient and reliable storage/retrieval process.

Referring now to FIG. 11a, there is illustrated a general diagram of the terminal 200, and the locations of the exterior door 210 and interior door 211 thereof.

Referring now to FIG. 11b, there is illustrated a more detailed view of the terminal 200. As indicated hereinabove, the terminal 200 facilitates entry and exit of an item of the warehouse facility 100. The terminal 200 includes the exterior door 210 that provides access by an item to the exterior of the automated warehouse facility 100 once retrieved, and entry to the automated warehouse facility 100 for storage, and the interior door 211 (in a cutaway portion) that provides access to the interior of the automated warehouse facility 100. The exterior and interior doors (210 and 211) can be roll-up doors such that the “up” position puts either door on a rail in the ceiling area of the terminal 200. In normal operation, only one door is open at any point in time.

The terminal 200 has a ceiling 1100 that is closed off to preclude exposure to mechanisms that may be constructed overhead. Similarly, the terminal 200 includes a first sidewall 1102 and a second sidewall 1104, both of which are constructed for safety purposes to prevent exposure to the mechanisms interior to the automated warehouse facility 100. The level area 1103 of the terminal 200 includes the pallet 212 and the walkways 214 on either side of the pallet 212 so that the customer can access the item from the walkways 214. The top of the pallet 212 is positioned substantially at the floor level with the walkways 214 to presenting potential trip hazards to customers. In accordance with one embodiment of the subject application, the pallet 212 is capable of including a pair of guides 1108 into which the vehicle tires should enter when the item is a vehicle that is driven onto the pallet 212. This guides the customer for determining where to park the vehicle on the pallet 212. In accordance with another embodiment of the subject application, the pallet 212 includes guides 1108 to facilitate the loading of the item on the pallet 212, e.g., rails, rollers, or the like, so as to provide ease of movement of the item onto and off of the pallet 212.

In this particular embodiment, an automated teller 1106 is provided exterior to the terminal 200 that the customer accesses to purchase the storage service, and to initiate the storage process. Once the transaction is completed, the customer makes a selection that initiates the storage process, causing the exterior door 210 to close. The interior of the terminal 200 is capable of including one or more motion sensors (not shown in the drawing) that prevent initiation of the automated warehouse facility mechanisms by the automated facility control system when motion is detected by the presence of the customer (and/or passengers) in the interior of the terminal 200. Thus when the customer has paid for the storage service, and the customer (and all passengers) have vacated the terminal 200, the motion sensors indicate as such, and the control system of the warehouse facility 100 then enables the storage procedure for that item.

In one embodiment, to facilitate security and safety of the storage process at least two cameras (not shown) adapted for monitoring the interior of the terminal 200, are installed in the terminal 200. The cameras are adapted to capture images of the interior of the terminal 200 prior to a vehicle entering the terminal 200. The cameras are further adapted to capture images of the interior of the terminal 200 prior to initiating the storage process, the latter assuring an operator that no customer (and all passengers) are present in the vehicle. The cameras are further adapted to capture images of the interior of the terminal 200 prior to the customer driving off at retrieval for obtaining images of the status of the vehicle before the retrieval.

At the terminal 200, the transaction includes either giving a ticket, reading an RF (radio frequency) tag (e.g., an EZ pass or the like), or reading a credit card or other type of magnetic card. It is appreciated that other conventional transaction methods can also be provided with suitable accommodations for processing such transactions, such as for example and without limitation, paper tickets or tokens. Once the customer returns and wants the stored item returned, the customer simply goes to the lobby 124 where a ticket reader, credit card reader, or RF reader is used to process the corresponding method for clearing payment, thereby initiating retrieval of the stored item. A message center in the lobby 124 then informs the customer where to pick up the retrieved item (i.e., which of the terminal 200 or terminals).

As indicated above, more robust implementations of the automated teller 1106 are capable of accommodating payment methods that include cash, debit cards, rechargeable pre-purchased storage debit cards, accounts, or many other conventional means for completing the transaction. Additionally, the automated teller 1106, and other automated tellers associated with the other terminals 200 of the warehouse facility 100 are networked to one or more computer systems or credit card clearing houses that facilitate the use of the aforementioned payment methods. In accordance with one embodiment of the subject application, when a credit card is used for payment of any fees associated with the storage of an item, the teller 1106 interfaces with a data network that provides access to the credit database of the card user clearing house so that payment can be properly authorized. Such access includes, for example and without limitation, access provided via a packet-switched network such as the Internet, by the circuit-switched network of the Public Switched Telephone Network, or GPS (global positioning system).

Additionally, the warehouse facility 100 is capable of being suitably constructed so as to provide services other than storage services to the customer. In accordance with one embodiment of the subject application, the customer is capable of requesting the performance of one or more additional services to be performed on the associated item during storage in the warehouse facility 100. For example, the customer is capable of requesting, during access to the automated teller 1106, that the item be washed during the time in which the item is stored in the warehouse facility 100. Continuing with this example, when a washing module (not shown) is incorporated into the warehouse facility 100, the item is transported to the washing module and returned to the storage location upon completion of the requested service. When no washing module is available, the warehouse attendant is made aware of the additional services purchased by the customer via any suitable means, e.g., electronic notification, printout, voice, etc., whereupon the attendant retrieves the item, performs, if able the requested service, and returns the item to the assigned rack in the warehouse facility 100. The skilled artisan will appreciate that other services are also capable of being provided to customers, as desired by the warehouse facility owner. For example and without limitation, alternate embodiments of the subject application include item maintenance services, repair services, detailing, cleaning, and the like.

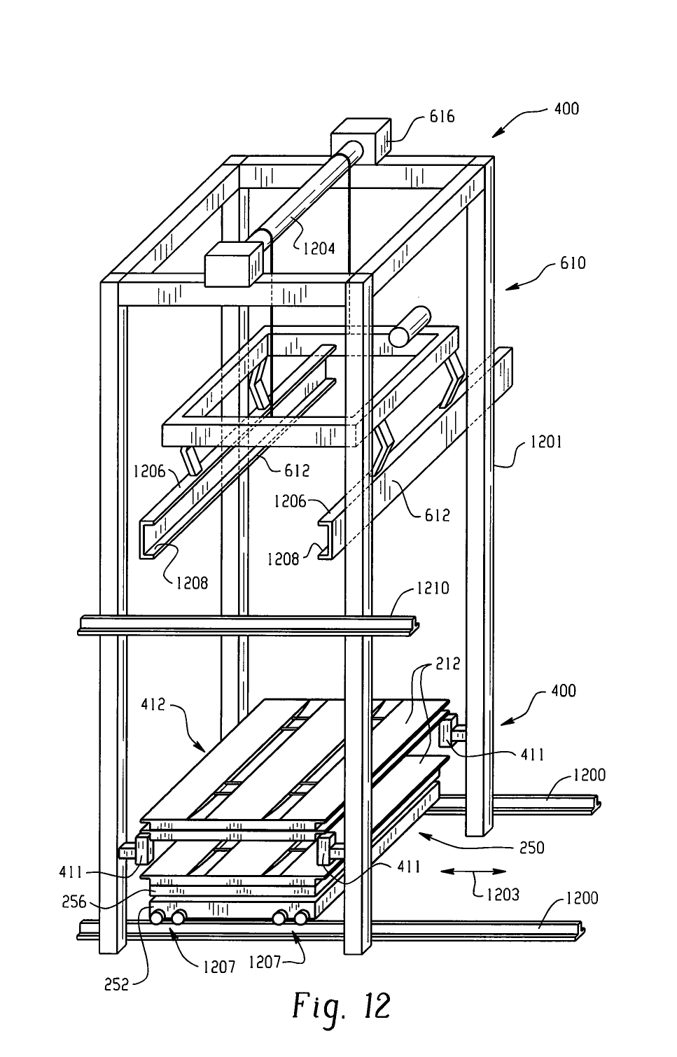

Referring now to FIG. 12, there is illustrated a more detailed isometric of the pallet stacking station assembly 400 that includes the pallet stack support mechanism 410 and pallet vertical lift 610. In this particular embodiment, the pallet stacking station 400 is constructed into a multi-level steel beam framework 1201 suitable for supporting and lifting the pallet bundle 412. The pallet stacking station 400 includes the pallet stack support mechanism 410 in which pallets are either accumulated from the terminal 200 when items are retrieved for a customer, and removed from the pallet bundle 412 for use in the terminal 200 in preparation to receive an item. The pallet stacking station 400 is constructed over a shuttle rail system 1200 that accommodates the pallet shuttle 250. The pallet vertical lift 610 is suspended from the framework 1201 such that it can be lowered to either replace or remove the pallet stack 412 of the pallet stack support mechanism 410. Thus the pallet vertical lift 610 operates over the height of several level s, in accordance with the particular warehouse facility design, such that when the pallet stack 412 is to be handled, the pallet stack 412 can be elevated to and from upper (or lower level s).

The pallet stacking station 400 includes the pallet vertical lift motor 616 (e.g., an electro-mechanical motor) that operates in accordance with control signals from the central control system to either raise or lower the pallet vertical lift 610 by driving a rotating shaft 1204 to take in or let out the pallet vertical lift support 614 (i.e., a suspension means, or any other suitable means).

In operation, the pallet shuttle 250, when receiving control signals from the control system computer, traverses the shuttle rail system 1200 in a lateral (or x-axis) direction 1203 from the terminal 200, and is positioned under any of the pallet stacking station 400 of the automated warehouse facility 100. The pallet shuttle 250 includes two pairs of steel shuttle wheels 1207 at each end that engage the shuttle rail system 1200. When bringing the pallet 212 to the pallet stacking station 400, the control system signals the pallet shuttle elevation mechanism 254 (not shown) contained in the pallet shuttle base 252 of the pallet shuttle 250 to lift the pallet shuttle support platform 256. The pallet shuttle support platform 256 is raised to a point such that the supported pallet 212 on the pallet shuttle support platform 256 contacts the lowest pallet of the pallet bundle 412, and continues rising forcing the pallet bundle 412 vertically to a height sufficient to allow the pallet stack support mechanism 410 to capture the pallet 212 by engaging the support latches 411. The pallet shuttle support platform 256 then lowers to a transport position such that the pallet shuttle 250 can traverse the shuttle rail system 1200 in accordance with instructions from the automated warehouse facility control system.

In a scenario where the pallet bundle 412 is removed from the pallet stacking station 400 for storage, the pallet vertical lift 610 is controlled to lower about the pallet bundle 412. The tongs 612 are in an open stance for clearing the pallet bundle 412, and the pallet vertical lift 610 is lowered to a point where the top edge 1206 of the tongs 612 is just lower than the bottom of the lowest pallet of the pallet bundle 412. The tongs 612 are then closed and secured for lifting the pallet bundle 412, after the pallet stack support mechanism 410 disengages the stack latches 411. The pallet vertical lift 610 then rises to a level predetermined by the automated warehouse facility control system. When brought into position at the designated level, the pallet vertical lift 610 is aligned at that level such that the lower portion 1208 of the channel beam of the tongs 612 facilitates insertion of a rack entry module (not shown) for removal of the pallet bundle 412 from is the pallet vertical lift 610. An upper carrier module assembly (described in greater detail below) that comprises the rack entry module and upper carrier module accesses the pallet vertical lift 610 from an upper carrier module rail system 1210 of that level.

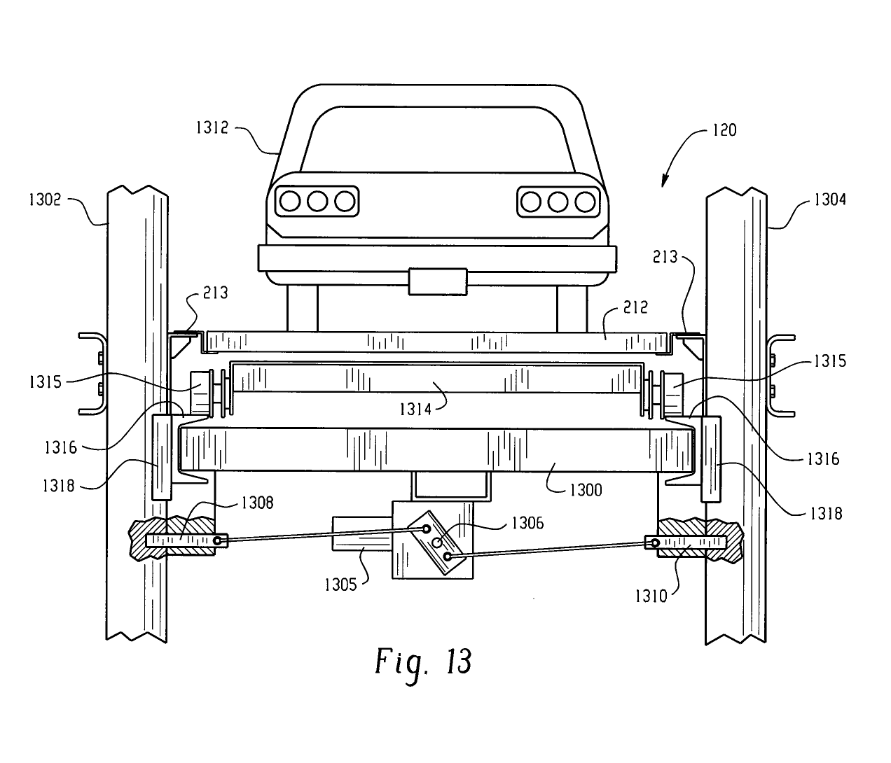

Referring now to FIG. 13, there is illustrated an end view of the vertical lift conveyor assembly 120. As indicated hereinabove, the vertical lift conveyor assembly 120 operates to transport only loaded in the vertical (or z-axis) direction between the various level s of the automated warehouse facility 100. The vertical lift conveyor 120 is constructed within the steel girder facility of the garage 100 so that a carriage 1300 engages each of four beams at its corners when reaching the appropriate level (or levels). As illustrated, the unloaded carriage 1300 is positioned in a locking mode at a level of the automated warehouse facility 100 where one end of the carriage 1300 is positioned between two end girders (1302 and 1304). The carriage 1300 includes an electromechanical means 1305 that operates in accordance with control signals from the central control system to rotate a locking shaft 1306 to cause two pairs of opposing locking pins to engage the corner girders. Here, one pair of pins (1308 and 1310) is illustrated as engaged to respective two corner columns (1302 and 1304) out of the four available. The electromechanical means 1305 connects to another shaft near the other end of the carriage 1300 to control locking pins at that end in a similar manner.

In this particular rendition, the vertical lift conveyor 120 is shown with a loaded pallet 212 (i.e., supporting a vehicle 1312). Note that the vertical lift conveyor 120 accommodates the loaded pallet 212 in the same way the pallet 212 is supported by the retractable pallet support mechanism 216 of FIG. 2, that is, by the pallet lips 213. The rack entry module 1314 associated with the particular level is shown inserted into that vertical lift conveyor 120 under the loaded pallet 212 such that the pallet 212 can be raised sufficiently to remove the loaded pallet 212 from the vertical lift conveyor 120 (for a removal operation). The rack entry module 1314 includes the wheels 1315 for rolling the rack entry module 1314 into the vertical lift conveyor 120 on vertical lift conveyor rails 1316. The carriage 1300 also includes corner assemblies 1318 at each corner thereof that connect to vertical lifting means (not shown), for example, chains, so that the carriage 1300 can be raised or lowered within the vertical shaft of the vertical lift conveyor 120 defined by the corner girders.

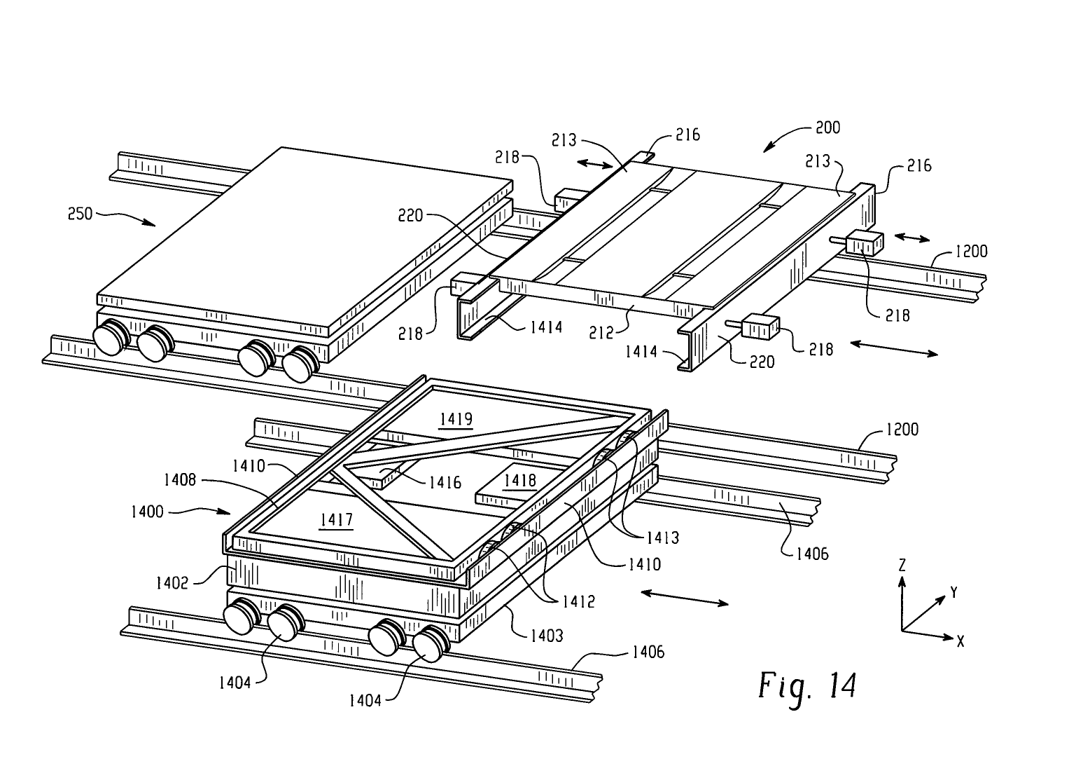

Referring now to FIG. 14, there is illustrated a more detailed view of the mechanisms utilized for retrieving and replacing a pallet, loaded or unloaded, in the terminal 200. As illustrated, the unloaded pallet 212 is resting on the tracks 220 within the terminal 200. The tracks 220 can be retracted utilizing a number of track retractors 218, which are electro-mechanical devices operating under control of the automated warehouse facility control system. That is, when the pallet 212 is to be retrieved from or returned to the pallet stacking station 400 (not shown), the track retractors 218 operate to spread the tracks 220 (along the x-axis) sufficiently so that the pallet 212 can be lowered downward (in the z-axis) by the pallet shuttle 250. Similarly, when the pallet 212 is being returned to the terminal 200 from the pallet stacking station 400, and elevated from below into position such that the pallet lips 213 are just above the supporting surface of the tracks 220, the track retractors 218 operate to move the tracks 220 inward so that the pallet 212 can be lowered the short distance thereonto. Note the pallet shuttle 250 travels under the terminal 200 on the shuttle rail system 1200, as indicated hereinabove. Note also that the pallet stacking station 400 need not be adjacent to the terminal 200, since the shuttle rail system 1200 facilitates travel to virtually any location along the length of the automated warehouse facility 100.

When a customer has departed the terminal 200, and initiated the storage procedure for an item, a type of carrier module 110 utilized on the entrance level of the automated warehouse facility 100, denoted hereinafter as a lower carrier module system 1400, is moved into alignment with the terminal 200 by the automated warehouse facility control system. The lower carrier module system 1400 includes an lower carrier module turntable 1402 that rotates 180 degrees in a horizontal plane, a lower carrier 1403 having carrier wheels 1404 on each end that provide for traversing the length of the garage 100 (on the x-axis) on an lower carrier module rail system 1406, and a lower rack entry module (rack entry module) 1408 for insertion into the terminal 200 (in the y-axis). Note that the number and orientation of the lower carrier wheels 1404 are such that at least one wheel 1404 of a pair is always in a supporting role of the lower carrier 1403 on the lower carrier module rail system 1406.

The lower carrier module turntable 1402 includes a rail (or wheel guide) 1410 on each side into which the wheels 1412 on either side of the lower carrier rack entry module 1408 travel. The lower carrier rack entry module rails 1410 of the lower carrier module turntable 1402 are designed to align with a lower inside L-portion 1414 of the channel beams that function as the tracks 220 that support the loaded pallet 212 in the terminal 200. The lower inside L-portion 1414 of each track 220 functions as a rail over which the wheels 1412 roll in order to position the lower carrier rack entry module 1408 under the pallet 212. Note that the rails 1410 need not be in close proximity or direct contact with the corresponding lower inside L-portion 1414, since the rack entry module wheels 1412 are grouped into pairs that are suitably spaced in a supporting role. If the loaded pallet 212 is selected for storage on the current level, the lower carrier module system 1400 moves to the designated storage slot 114, and the rack entry module 1408 extends into either the interior storage rack 116 or fully to the exterior storage rack 118 to store the loaded pallet 212.

Alternatively, if the automated warehouse facility control system directs that the loaded pallet 212 is to be stored on a different level, the lower carrier module system 1400 and loaded pallet 212 move to the vertical lift conveyor 120 (not shown) where the loaded pallet 212 is placed into the vertical lift conveyor 120 for vertical movement to the other level.

The lower carrier rack entry module 1408 of the lower carrier module system 1400 includes a lower rack entry module control means 1416 that communicates with the automated warehouse facility control system to process signals that control functions of the lower carrier rack entry module 1408, including movement into and out of the terminal 200 and elevation of an elevating means. The lower rack entry module control means 1416 connects electrically to a first wheel drive section 1417, which first wheel drive section 1417 includes the following general components (that are not illustrated here, but are shown in greater detail in FIG. 17): a first drive means, a first transfer means, and a first set of four wheels 1412 with a pair located on each side and near the end of the rack entry module chassis. The lower rack entry module control means 1416 also connects electrically to a second wheel drive section 1419, which second wheel drive section 1419 includes a second drive means, a second transfer means, and a second set of four wheels 1413 with a pair located on each side and near the opposite end of the rack entry module chassis. The first and second drive means may be one or more electromechanical motors that drive the wheels (1412 and 1413) so that the lower carrier rack entry module 1408 moves along the y-axis into and out of the tracks 220 of the terminal 200. The first and second transfer means that transfer the drive torque from the first (and second) drive means to the wheels 1412 (and 1413) can include any combination of conventional equipment such as shafts, gears, belts and pulleys, or chains that suitably designed into the lower carrier rack entry module 1408 to facilitate such functions.

The lower rack entry module 1408 also includes a lower rack entry module elevator motive means 1418 under control of the lower rack entry module control means 1416 so that an elevator component (not shown) of the lower rack entry module 1408 can be raised to support the loaded or unloaded pallet 212 in the terminal 200, and lowered for transport of the pallet and/or vehicle along the lower carrier module rail system 1406. The elevator component comprises a platform for mating with the underside of the pallet 212 to prevent shifting of the pallet 212 during transport. The lower rack entry module elevator motive means 1418 includes one or more electric motors of sufficient operating parameters to drive raising and lowering of the pallet 212 when loaded. The elevator component can include several screw jacks, screw actuators, or similar means that connect to the lower rack entry module elevator motive means 1418 to facilitate the elevating process of the lower carrier rack entry module 1408.

The lower carrier 1403 also includes a lower carrier control means (not shown) in communication with the automated warehouse facility control system, and a lower carrier drive means (not shown) both of which facilitate operation thereof along the lower carrier module rail system 1406 to position the lower carrier module 1400 in alignment with the tracks 220. Once aligned, the lower carrier rack entry module 1408 moves along the tracks 220 under the pallet 212, and raises the pallet 212 sufficiently to clear the tracks 220, and exits the terminal 200 back onto the lower carrier module 1402 with the pallet 212. Of course, the lower carrier rack entry module 1408 is of a width that allows it to be inserted between the tracks 220 when the tracks are closed in a supporting role, to support the pallet 212 for removal from the terminal 200. As described, the track retractors 218 need not be operated when removing or retrieving a loaded pallet 212 from the terminal 200.

Note that lower carrier module assembly 1400 is only operable on the entrance level, while the upper carrier module assembly operates on any level other than the entrance level. Levels other than the entrance level have only a fraction of the item-handling load performed on the entrance level. Thus the upper carrier module assembly is more often available to move the pallet bundle 412 in and out of the pallet vertical lift 610, and into and out of storage slots on those levels. The vertical lift conveyor 120 and lower carrier module assembly 1400 preferably are never utilized to handle pallet bundles 412 or an empty pallet; these machines should only handle loaded pallets. The upper carrier module assemblies handle only a portion of the items depending on the number of level s in the automated warehouse facility 100.

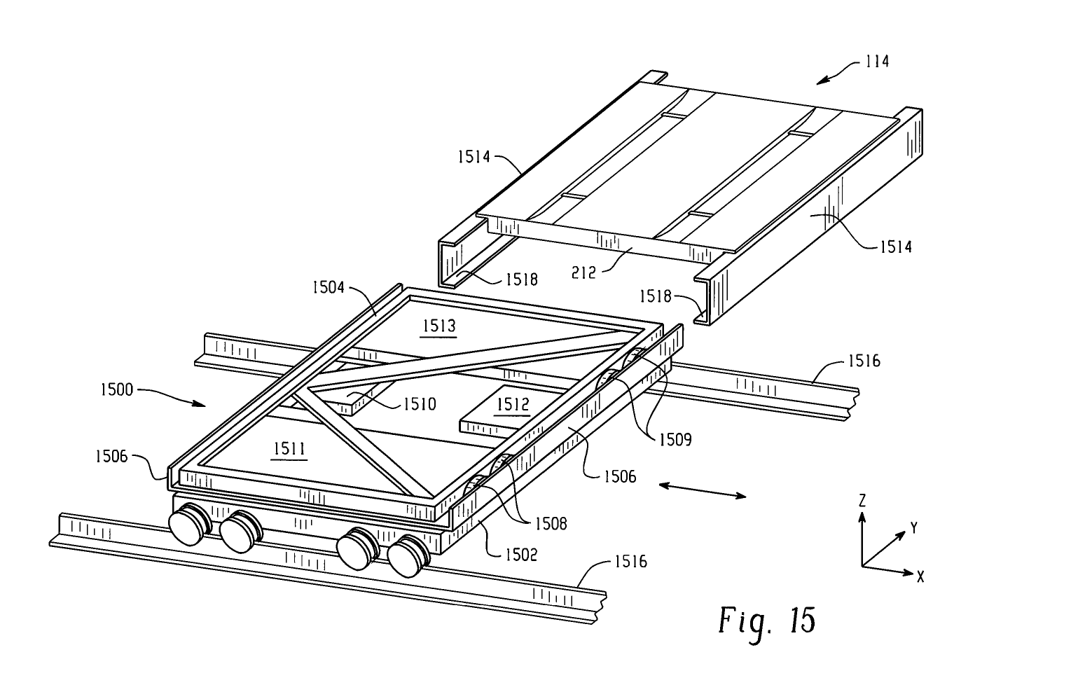

Referring now to FIG. 15, there is illustrated the carrier module 110 utilized in the levels of the automated warehouse facility 100 other than the entrance level, and hereinafter denoted specifically as an upper carrier module (upper carrier module) assembly 1500. The upper carrier module assembly 1500 includes an upper carrier 1502 and an upper carrier rack entry module 1504 (similar to lower carrier rack entry module 1408). The upper carrier 1502 is similar to the lower carrier 1403 of the lower carrier module system 1400, except that the upper carrier 1502 includes upper carrier rails (or wheel guides, similar to the rails 1410 of the lower carrier module system 1400) 1506 within which wheels 1508 (similar to the wheels 1412 of the lower carrier rack entry module 1408 of the lower carrier module system 1400) situated on either side of the upper carrier rack entry module 1504 travel to facilitate movement of the upper carrier rack entry module 1504 along the y-axis. Thus generally, the only difference between the lower carrier module assembly 1400 and the upper carrier module assembly 1500 is that the lower carrier module assembly 1400 includes the lower carrier module turntable 1402 with the rails 1410, and the upper carrier module assembly 1500 includes the upper carrier 1502 with the rails 1506, but not turntable feature. The upper carrier module system 1500 includes an upper rack entry module control means 1510 and an upper rack entry module motive means 1512, both of which provide similar functions as the corresponding control means 1416 and motive means 1418 of the lower carrier rack entry module 1408.

The upper rack entry module control means 1510 communicates with the automated warehouse facility control system to process signals that control functions of the upper carrier rack entry module 1504, including movement into and out of the storage slot 114 (extending across the interior storage rack 116 to the exterior storage rack 118) and elevation of an elevating means. The upper rack entry module control means 1510 connects electrically to a first wheel drive section 1511, which first wheel drive section 1511 includes the following general components (that are not illustrated here, but are shown in greater detail in FIG. 17): a first drive means, a first transfer means, and a first set of four wheels 1508 with a pair located on each side and near the end of the upper carrier rack entry module chassis. The upper rack entry module control means 1510 also connects electrically to a second wheel drive section 1513, which second wheel drive section 1513 includes a second drive means, a second transfer means, and a second set of four wheels 1509 with a pair located on each side and near the opposite end of the upper carrier rack entry module chassis. The first and second drive means may be one or more electromechanical motors that drive the wheels (1508 and 1509) so that the upper carrier rack entry module 1504 moves along the y-axis into and out of tracks 1514 of the storage slot 114. The first and second transfer means that transfer the drive torque from the first (and second) drive means to the wheels 1508 (and 1509) can include any combination of conventional equipment such as shafts, gears, belts and pulleys, or chains that suitably designed into the upper carrier rack entry module 1504 to facilitate such functions.

The upper carrier rack entry module 1504 also includes an upper rack entry module elevator motive means 1512 under control of the upper rack entry module control means 1510 so that an elevator component (not shown) of the upper carrier rack entry module 1504 can be raised or lowered while supporting the loaded or unloaded pallet 212, and further lowered for transport of the pallet 212 and/or vehicle along a upper carrier module rail system 1516. The elevator component comprises a platform for mating with the underside of the pallet 212 to prevent shifting of the pallet 212 during transport. The upper carrier rack entry module elevator motive means 1512 includes one or more electric motors of sufficient operating parameters to drive the raising and lowering of the pallet 212 when loaded. The elevator component can include several screw jacks that connect to the upper carrier rack entry module elevator motive means 1512 to facilitate the elevating process of the upper carrier rack entry module 1504. The upper carrier 1502 includes similar arrangements, e.g., a control box, drive sets, etc., to move in the x-axis along the aisles of the associated level s.

In this particular scenario, the unloaded pallet 212 is stored in one of the many vehicle storage slots 114 of the upper (or lower) levels of the automated warehouse facility 100. Thus the storage slot 114 includes the support beams 1514 that are fixed within the automated warehouse facility. Similar to the lower carrier module system 1400 mentioned hereinabove, the upper carrier module system 1500 operates over the upper carrier module rail system 1516 extending essentially the length of the automated warehouse facility 100. Each level includes a single upper carrier module rail system 1516 and one or more upper carrier module systems 1500 operating independently under control of the automated warehouse facility control system to retrieve or store loaded and unloaded pallets 212.

In operation, the upper carrier module system 1500 moves into alignment with the storage slot 114 under control of the automated warehouse facility control system. The alignment process is similar to that of the lower carrier module system 1400 such that the upper carrier wheel guides 1506 are aligned with a lower L-portion 1518 of the corresponding support beams 1514. The upper carrier rack entry module 1504 is then controlled to move onto the lower L-portion of the support beams 1514 in a position under the pallet 212. The carrier module 1502 remains in alignment position while the upper carrier rack entry module 1504 elevates to support the pallet 212. The upper carrier rack entry module 1504 is then controlled to return onto the upper carrier 1502. Similar to operation of the lower carrier rack entry module 1408, upon return, the upper carrier rack entry module 1504 lowers back to a more stable position onto the upper carrier 1502 for transport of the pallet 212 to one of the several vertical lift conveyors 120.

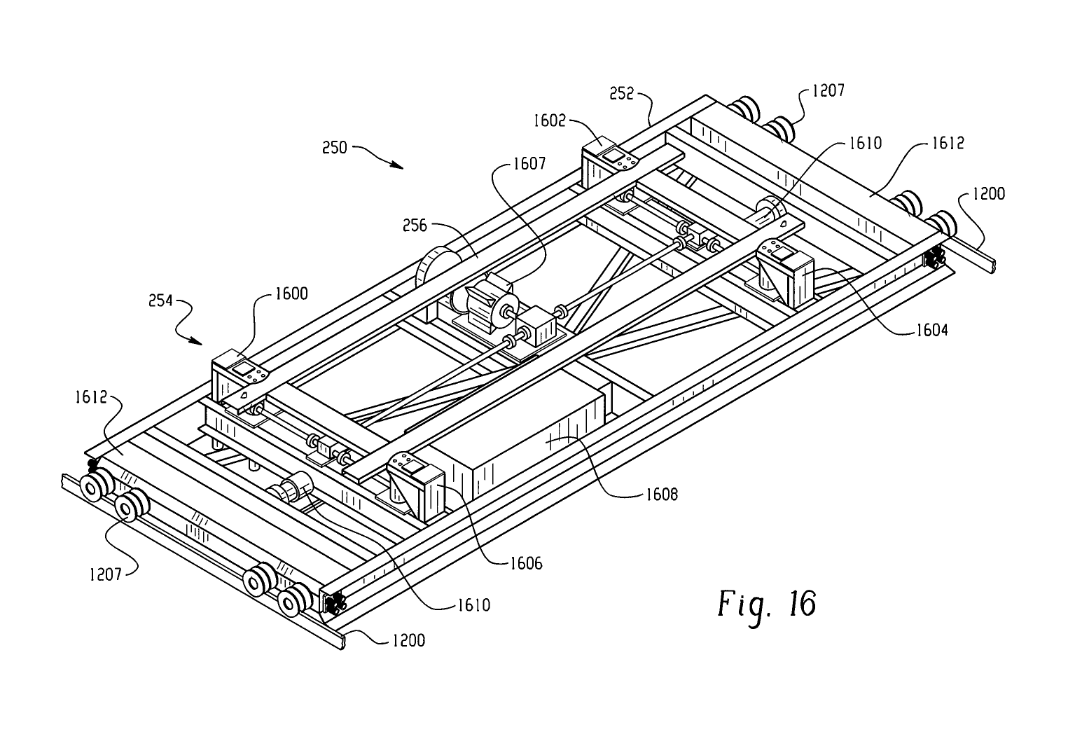

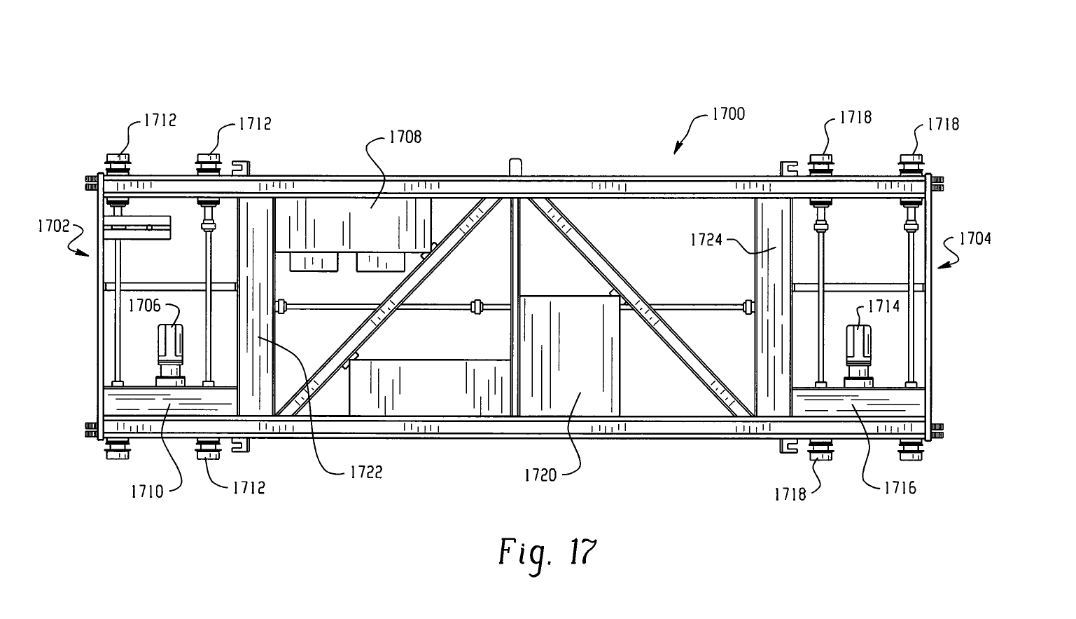

Referring now to FIG. 16, there is illustrated a more detailed mechanical view of the pallet shuttle 250. As indicated hereinabove, the pallet shuttle 250 comprises the pallet shuttle base 252, the pallet shuttle elevation mechanism 254, and pallet shuttle support platform 256. The pallet shuttle base 252 includes the shuttle wheels 1207 on each end that are in rolling contact with the shuttle rail system 1200. The pallet shuttle elevation mechanism 254 comprises four mechanical screw actuators (1600, 1602, 1604, and 1606) that operate from an elevation drive means 1607 that is under the coordinated control of a shuttle control means 1608, which shuttle control means 1608 communicates with the automated warehouse facility control system at the control room 126 to facilitate operation of the pallet shuttle 250. The pallet shuttle elevation mechanism 254 elevates between the tracks 220 when in the terminal 200 to position sufficient to support the unloaded pallet so that the tracks 220 can be retracted (or spread apart) by the track retractors 218. When operating with the pallet stacking station 400, the pallet shuttle elevation mechanism 254 elevates to a position sufficient to support all of the pallets 212 currently stored in the pallet stacking station 400, and where stack latches 411 of the pallet stack support mechanism 410 can then move to support a portion of the bottom pallet of the stack of pallets 412.

The pallet shuttle base 252 includes one or more shuttle drive means 1610 (e.g., electric motors) for driving the wheels 1207 to travel along the shuttle rail system 1200, and to lock into position the pallet shuttle 250 when vertically aligned under the terminal 200 or any of the pallet stacking station 400 locations to handle the pallet 212. The drive means 1610 couple to corresponding gear boxes 1612 in which transfer equipment resides to couple the drive means 1610 to the corresponding wheel sets 1207. As indicated hereinabove, such transfer equipment can include belts, pulleys, gears, chains, and shafts as used conventionally with such equipment.

Referring now to FIG. 17, there is illustrated a more detailed mechanical view of a rack entry module 1700 (similar to lower carrier rack entry module 1408 and upper carrier rack entry module 1504). The rack entry module 1700 includes a first wheel drive section 1702 and a second wheel drive section 1704. The first wheel drive section 1702 includes a first wheel drive means 1706 (e.g., an electromechanical motor) that operates under control of a rack entry module control means 1708 (similar to lower carrier control means 1416 and upper carrier control means 1510). The first wheel drive means 1706 is mounted to a first transfer means 1710 such that torque provided therefrom is transferred to the wheels 1712 associated with the first wheel drive section 1702. As indicated hereinabove, such transfer is suitably provided by conventional mechanisms such as belts and pulleys, gears, chains and/or shafts.

Similarly, the second wheel drive section 1704 includes a second wheel drive means 1714 (e.g., an electromechanical motor) that operates under control of the rack entry module control means 1708. The second wheel drive means 1714 is mounted to a second transfer means 1716 such that torque provided therefrom is transferred to the wheels 1718 associated with the second wheel drive section 1704. Note that the first and second drive means (1706 and 1714) are operated synchronously by the rack entry module control means 1708. However, it will be understood by those skilled in the art that the first and second drive means (1706 and 1714) are also capable of operation independent of one another, which provides a back-up feature if one of the drive means (1706 or 1714) should fail.

The rack entry module 1700 also includes an elevator motive means 1720 under control of the rack entry module control means 1708 so that an elevator component (not shown) is capable of being raised or lowered while supporting the loaded or unloaded pallet 212, and further lowered for transport of the pallet 212 and/or vehicle. The elevator component comprises a platform for mating with the underside of the pallet 212 to prevent shifting of the pallet 212 during transport. The rack entry module elevator motive means 1720 includes one or more electric motors of sufficient operating parameters to drive the raising and lowering of the pallet 212 when loaded. The elevator component can include several screw actuators or similar means located in elevator gear boxes (1722 and 1724), and that connect to the rack entry module elevator motive means 1720 to facilitate the elevating process.

It will be appreciated by those skilled in the art that item storage operations in the storage area of the automated warehouse facility 100 (i.e., the area of item storage racks) and handling of loaded pallets to and from the terminal, are capable of being accomplished by a transport system, which transport system includes the vertical lift conveyor assembly 120, the lower carrier module system 1400, upper carrier module assembly 1500, carrier aisle systems, etc., although the upper carrier module are capable of being used to handle pallet bundles 412, which consist of unloaded pallets. As mentioned hereinabove, the pallet stacking station 400 handles only unloaded pallets.

Since the automated warehouse facility 100 includes a number of upper and lower module systems (1400 and 1500), as well as the pallet handling equipment and system—operating simultaneously and independently under control of the automated warehouse facility control system on various levels, it is appreciated that communication from the automated warehouse facility control system to the module systems (1400 and 1500) and to the pallet handling system is preferably, but not necessarily, wireless to preclude the need for large wiring harness and extensive routings of cable suspended throughout the automated warehouse facility. Thus each module system (1400 and 1500) and the equipment of the pallet handling system would communicate wirelessly with the automated warehouse facility control system via a unique frequency.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed is:

1. A fully automated warehousing and storage system, comprising
first passageway transport means associated with a first level of an automated warehouse facility adapted for transporting an item along a first passageway associated with the first level;
vertical lifting means adapted for lifting an item from the first level to the at least one additional level;
first transition means associated with the first passageway transport means adapted for transitioning the item to and from the vertical lifting means on the first level;
second passageway transport means associated with the at least one additional level of the automated warehouse facility adapted for transporting an item along a second passageway associated with the at least one additional level;
second transition means associated with the second passageway transport means, adapted for transitioning the item to and from the vertical lifting means on the at least one additional level; and
control means adapted for controlling the transfer of the item from the first level to the at least one additional level,
wherein the first passageway transport means, the second passageway transport means, and the vertical lifting means operate simultaneously.

2. The fully automated warehousing and storage system of claim 1, further comprising at least one additional passageway transport means associated with the first passageway adapted for transporting an item along the first passageway, wherein the at least one additional passageway transport means operates simultaneously with the first passageway transport means.

3. The fully automated warehousing and storage system of claim 2, further comprising at least one additional vertical lifting means adapted for lifting an item from the first level to the at least one additional level.

4. The fully automated warehousing and storage system of claim 3, wherein the item further comprises a pallet and at least one of the group consisting of a vehicle and a good.

5. The fully automated warehousing and storage system of claim 4, further comprising at least one terminal, the terminal including,
transfer means adapted for transferring an unloaded pallet from an associated pallet storage to the at least one terminal; and
receiving means adapted for receiving the unloaded pallet from the transfer means, wherein the transfer means returns to the pallet storage prior to loading of an item on the pallet.

6. The fully automated warehousing and storage system of claim 5, wherein the terminal further comprises rotating means adapted for rotating an item so as to enable entry and exit from the automated warehousing facility via the same terminal.

7. A fully automated warehousing and storage method, comprising the steps of:
transporting an item along a first passageway associated with a first level;
transitioning the item from the first passageway to a vertical lift;
lifting, via the vertical lift, the item from the first level to at least one additional level;
transitioning the item from the vertical lift to the at least one additional level;
transporting an item along a second passageway associated with the at least one additional level;
controlling the transfer of the item from the first level to the at least one additional level, wherein the transporting along the first passageway, the transporting along the second passageway, the lifting, and the transitioning operate simultaneously.

8. The fully automated warehousing and storage method of claim 7, further comprising the step of transporting at least one additional item along the first passageway, wherein the transporting of the at least one additional item operates simultaneously with the transporting of the item along the first passageway.

9. The fully automated warehousing and storage method of claim 8, further comprising the step of lifting, via at least one additional vertical lift, the at least one additional item to the at least one additional level.

10. The fully automated warehousing and storage method of claim 9, wherein the item further comprises a pallet and at least one of the group consisting of a vehicle and a good.

11. The fully automated warehousing and storage system of claim 10, further comprising at least one terminal, the terminal including,
transferring an unloaded pallet from an associated pallet storage to the at least one terminal; and
receiving the unloaded pallet; and
retrieving at least one additional pallet from the associated pallet storage simultaneously with the loading of an item on the pallet.

12. The fully automated warehousing and storage method of claim 11, further comprising the step of rotating an item so as to enable entry and exit from the automated warehousing facility via the same terminal.

13. A computer-implemented method for automated warehousing and storage, comprising the steps of:
transporting an item along a first passageway associated with a first level;
transitioning the item from the first passageway to a vertical lift;
lifting, via the vertical lift, the item from the first level to at least one additional level;
transitioning the item from the vertical lift to the at least one additional level;
transporting an item along a second passageway associated with the at least one additional level;
controlling the transfer of the item from the first level to the at least one additional level, wherein the transporting along the first passageway, the transporting along the second passageway, the lifting, and the transitioning operate simultaneously.

14. The computer-implemented method for automated warehousing and storage of claim 13, further comprising the step of transporting at least one additional item along the first passageway, wherein the transporting of the at least one additional item operates simultaneously with the transporting of the item along the first passageway.

15. The computer-implemented method for automated warehousing and storage of claim 14, further comprising the step of lifting, via at least one additional vertical lift, the at least one additional item to the at least one additional level.

16. The computer-implemented method for automated warehousing and storage of claim 15, wherein the item further comprises a pallet and at least one of the group consisting of a vehicle and a good.

17. The computer-implemented method for automated warehousing and storage of claim 16, further comprising at least one terminal, the terminal including,
transferring an unloaded pallet from an associated pallet storage to the at least one terminal; and
receiving the unloaded pallet; and
retrieving at least one additional pallet from the associated pallet storage simultaneously with the loading of an item on the pallet.

18. The computer-implemented method for automated warehousing and storage of claim 17, further comprising the step of rotating an item so as to enable entry and exit from the automated warehousing facility via the same terminal.
